(19) United States
(12) Patent Application Publication
(10) Pub. No.: US 2018/0105657 A1
(43) Pub. Date: Apr. 19, 2018

(54) POLYIMIDE FILM HAVING LOW GLOSS AND MANUFACTURE THEREOF

(71) Applicant: TAIMIDE TECHNOLOGY INCORPORATION, Hsinchu County (TW)

(72) Inventor: Wen-Hsuan Chung, Hsinchu Hsien (TW)

(21) Appl. No.: 15/365,679

(22) Filed: Nov. 30, 2016

(30) Foreign Application Priority Data
Oct. 19, 2016 (TW) 105133667

(51) Int. Cl. C08J 5/18; B29C 59/04; B29C 35/02

(52) U.S. Cl. CPC C08J 5/18; B29C 59/04; B29K 2079/08; C08J 2379/08; C08J 2479/08; B29C 35/02

(57) ABSTRACT

The present application provides a polyimide film having low gloss and a process of fabricating the same. The process includes forming a polyimide precursor solution by reacting diamine monomers with dianhydride monomers in a solvent, forming a wet polyimide film on a support with the polyimide precursor solution, pressing the wet film with an embossing roller at a temperature equal to or higher than 100° C. and an applied pressure equal to or higher than 1 kg, thereby causing the wet film to exhibit an uneven surface, and heating the wet film to form a polyimide film.

### CROSS-REFERENCE TO RELATED APPLICATION(S)

This application claims priority to Taiwan Patent Application No. 105133667 filed on Oct. 19, 2016, the disclosure of which is incorporated herein by reference.

### FIELD OF THE DISCLOSURE

The present application relates to a process of fabricating a polyimide film, and more particularly to a process of fabricating a polyimide film having an uneven surface exhibiting low gloss.

### BACKGROUND OF THE DISCLOSURE

Flexible copper clad laminates (FCCL) are widely used for making printed circuit board (PCB). Advantages of flexible copper clad laminates may include lightweight, thin and flexible properties. In addition, the flexible copper clad laminate generally includes a polyimide film that has advantageous electric and thermal characteristics. For example, the polyimide film can have a low dielectric characteristic (Dk) for rapid transport of electric signals, thermal characteristics promoting cooling, and a high glass transition (Tg) allowing satisfactory performance at a high temperature.

However, the polyimide film usually has high gloss owing to a highly flat surface that tends to reflect light. A film with high gloss may cause visual discomfort and eyestrain, especially for colored films with high gloss such as black, white, blue or red polyimide film.

On the other hand, a polyimide film having low light transmittance and low gloss is generally used as a substrate or coverlay for flexible printed circuit boards (FPCB), which are commonly used in computers, communication electronics, consumer electronics, optical lens modules, LCD modules and the like. The low light transmittance of the polyimide film can shield and protect the circuit design of a flexible printed circuit board, and the low gloss may provide a more appealing appearance.

One existing approach for reducing the gloss of a polyimide film is to incorporate a matting agent into the film. However, the addition of the matting agent increases the manufacture cost, and may cause adverse brittleness of the polyimide film.

Therefore, there is a need for a polyimide film that has desirable characteristics and can be fabricated in a cost-effective manner, and overcome the aforementioned issues.

### SUMMARY

The present application provides a process of fabricating a polyimide film having low gloss. The process includes forming a polyimide precursor solution by reacting diamine monomers with dianhydride monomers in a solvent, forming a wet polyimide film on a support with the polyimide precursor solution, pressing the wet film with an embossing roller at a temperature equal to or higher than 100° C. and an applied pressure equal to or higher than 1 kg, thereby causing the wet film to exhibit an uneven surface, and heating the wet film to form a polyimide film.

### BRIEF DESCRIPTION OF THE DRAWINGS

FIG. 1 is a flowchart illustrating a process of preparing a polyimide film with low gloss;

FIG. 2 is a schematic view illustrating an intermediate stage corresponding to a process step, according to an example embodiment of the disclosure;

FIG. 3 is a schematic view illustrating an intermediate stage corresponding to a process step, according to an example embodiment of the disclosure; and

FIG. 4 is a schematic view illustrating an intermediate stage corresponding to a process step, according to an example embodiment of the disclosure.

### DETAILED DESCRIPTION OF THE EMBODIMENTS

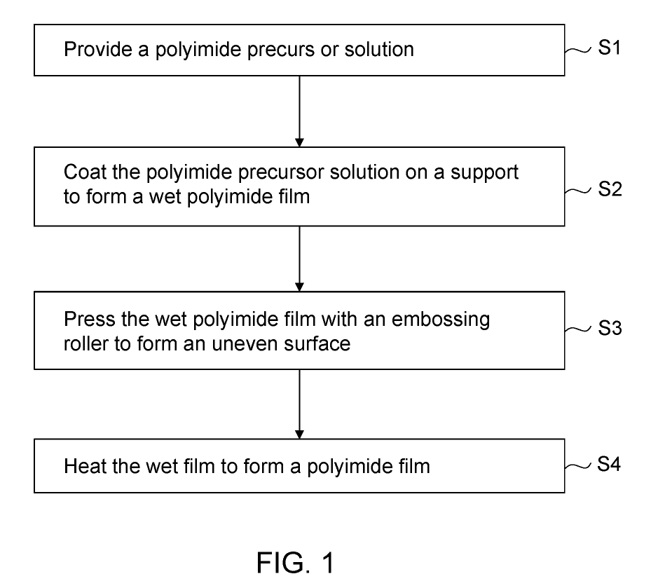

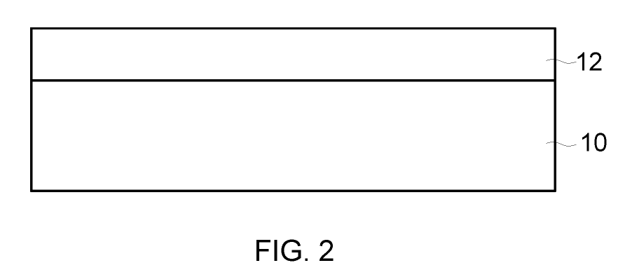

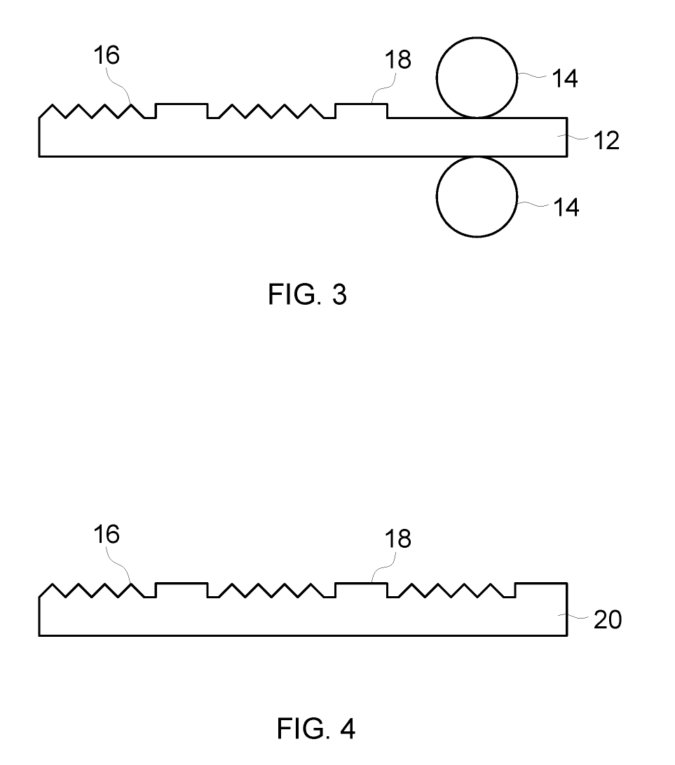

The present application describes a polyimide film having low gloss and a process of fabricating the polyimide film. FIG. 1 is a flowchart illustrating processing steps of preparing a polyimide film having low gloss, and FIGS. 2-4 are schematic views illustrating some intermediate stages corresponding to the process steps described in the flowchart of FIG. 1.

In initial step S1, a polyimide precursor solution is provided, which contains a solvent and a polyamic acid formed by reacting diamine monomers with dianhydride monomers. The solvent can be present in a quantity between about 20% and about 50% of the polyimide precursor solution. The solvent can be an aprotic polar solvent. Moreover, the solvent can have a relatively low boiling point (e.g., below about 225° C.) so as to facilitate its removal from the polyimide film at a relatively low temperature. Examples of suitable solvents may include dimethylacetamide (DMAC), N,N′-dimethylformamide (DMF), and the like.

Examples of the diamine monomers may include 4,4′-oxydianiline (4,4′-ODA), phenylenediamine (p-PDA), 2,2′-bis(trifluoromethyl)benzidine (TFMB), 1,3-bis(4-aminophenoxy)benzene (TPER), 1,4-bis(4-aminophenoxy)benzene (TPEQ), 2,2′-dimethyl[1,1′-biphenyl]-4,4′-diamine (m-TB-HG), 1,3′-bis(3-aminophenoxy) benzene (APBN), 3,5-diamino benzotrifluoride (DABTF), 2,2′-bis[4-(4-aminophenoxy) phenyl]propane (BAPP), 6-amino-2-(4-aminophenyl) benzoxazole (6PBOA), 5-amino-2-(4-aminophenyl) benzoxazole (SPBOA). The aforementioned diamines can be used individually or in combination. In some examples of implementation, the diamine monomers may be selected from the group consisting of 4,4′-ODA, p-PDA and TFMB.

Examples of the dianhydride monomers may include 3,3′,4,4′-biphenyltetracarboxylic dianhydride (BPDA), 2,2-bis[4-(3,4dicarboxyphenoxy) phenyl] propane dianhydride (BPADA), pyromellitic dianhydride (PMDA), 2,2′-Bis-(3,4-dicarboxyphenyl) hexafluoropropane dianhydride (6FDA), 4,4-oxydiphthalic anhydride (ODPA), benzophenonetetracarboxylic dianhydride (BTDA), 3,3′,4,4′-dicyclohexyltetracarboxylic acid dianhydride (HBPDA). The aforementioned dianhydrides can be used individually or in combination. In some examples of implementation, the dianhydride monomers may be selected from the group consisting of PMDA, BPDA and BPADA.

In step S1, a matting agent may be further incorporated into the polyimide precursor solution. Examples of the matting agent can include polyimide particles. Further examples of the matting agent may include an inorganic matting agent such as silica, alumina, titania, calcium carbonate, barium sulfate and the like, or an organic matting agent such as polycarbonate (PC), polystyrene (PS), poly(methyl methacrylate)(PMMA), polyethylene (PE), polypropylene, polyethylene terephthalate (PET), epoxy resin and the like.

In some examples of implementation, a pigment may also be incorporated in the provided polyimide precursor solution. The pigment may be an organic pigment or inorganic pigment, which may include black pigments, white pigments, red pigments, orange pigments, yellow pigments, green pigments, blue pigments or purple pigments. Examples of black pigments may include carbon black, cobalt oxide, Fe—Mn—Bi black, Fe—Mn oxide spinel black, (Fe,Mn)₂O₃ black, copper chromite black spinel, lampblack, bone black, bone ash, bone char, hematite, iron oxide black, micaceous iron oxide, black complex inorganic color pigment (CICP), CuCr₂O₄ black, (Ni,Mn,Co)(Cr,Fe)₂O₄ black, aniline black, cyanine black, perylene black, anthraquinone black, chrome green black hematite, and iron-chromium mixed oxides. The aforementioned pigments can be used individually or in combination.

In next step S2, the polyimide precursor solution can be coated on a support 10 to form a wet polyimide film 12, as shown in FIG. 2. The support 10 can be a steel belt, for example.

In step S3, the wet polyimide film 12 is separated from the support 10 and then pressed with an embossing roller 14, thereby forming an asperity structure 16 and a pattern 18 on at least one surface of the wet polyimide film 12. Step S3 may be conducted with the embossing roller 14 heated to a temperature equal to or higher than 100° C. For example, suitable temperatures of the embossing roller 14 can include 110° C., 150° C., 180° C., 200° C., 250° C., 300° C., or any intermediate values between the aforementioned values. According to an example of implementation, step S3 may be performed with a temperature of the embossing roller 14 between 160° C. and 190° C. Moreover, step S3 may be conducted with the embossing roller 14 applying a pressure equal to or higher than 1 kg on the wet film. Suitable pressures can include 2 kg, 5 kg, 10 kg, 15 kg, 20 kg, 25 kg, or any intermediate values between the aforementioned values. According to an example of implementation, the applied pressure can be between 4 kg and 8 kg.

The asperity structure 16 and pattern 18 formed on the surface of the wet polyimide film 12 may include regular and/or irregular asperity structures and patterns. For example, the asperity structure 16 can include regular and/or irregular indentations or protrusions. The pattern 18 can include any predetermined shape impressed on the surface of the wet polyimide film 12, which can be a logo, a mark, a graph, a character, a symbol and the like, or any combination thereof.

In next step S4, the wet polyimide film 12 is then heated to form a polyimide film 20 having an uneven surface including the asperity structure 16 and the pattern 18. The uneven surface of the polyimide film 20 thereby formed can have a reduced gloss value. According to one example of implementation, the formed uneven surface of the polyimide film 20 can have a 60° gloss value equal to or less than 60 gloss units (GU).

More detailed examples of preparing low-gloss polyimide films are described hereinafter.

### EXAMPLES AND COMPARATIVE EXAMPLES

Preparation of a Polyimide Precursor Solution

In a DMAC solvent, 4,4′-ODA diamine monomers and PMDA dianhydride monomers are polymerized to form a polyimide precursor solution of polyamic acid.

### Example 1

About 6 wt % of a polyimide powder used as matting agent is mixed with the polyimide precursor solution (containing about 20 wt % of solvent), which is then coated on a steel belt to form a wet polyimide film. The wet polyimide film is removed from the steel belt, and then pressed with an embossing roller. The embossing roller has an uneven patterned surface. The temperature of the embossing roller is 100° C., and the pressure applied by the embossing roller is 1 kg. The wet polyimide film then is heated to obtain a polyimide film.

### Examples 2-12 and Comparative Examples 1-2

Polyimide films are fabricated like in Example 1, except that the solvent content, the temperature and the pressure of the embossing roller are as indicated in Table 1.

Measure of 60° Gloss

A gloss meter (Micro Tri Gloss—BYK Gardner) is used to measure the 60° gloss value of the obtained polyimide films. The results shown in Table 1 are average values of three separate measures.

TABLE 1

| | | | Surface | Pressure | 60° |
|---|---|---|---|---|---|
| | Polyimide | | temperature | of | gloss |
| | powder | Solvent | of roller | roller | value |
| | (wt %) | (wt %) | (° C.) | (kg) | (GU) |
| Example 1 | 6 | 20 | 100 | 1 | 55 |
| Example 2 | 6 | 20 | 140 | 1 | 52 |
| Example 3 | 6 | 20 | 180 | 1 | 50 |
| Example 4 | 6 | 20 | 180 | 4 | 36 |
| Example 5 | 6 | 20 | 180 | 8 | 22 |
| Example 6 | 6 | 20 | 250 | 10 | 17 |
| Example 7 | 6 | 50 | 100 | 1 | 53 |
| Example 8 | 6 | 50 | 140 | 1 | 49 |
| Example 9 | 6 | 50 | 180 | 1 | 45 |
| Example 10 | 6 | 50 | 180 | 4 | 30 |
| Example 11 | 6 | 50 | 180 | 8 | 16 |
| Example 12 | 6 | 50 | 250 | 10 | 12 |
| Comparative | 6 | 20 | 90 | 0.8 | 85 |
| Example 1 | | | | | |
| Comparative | 6 | 50 | 180 | 0.8 | 80 |
| Example 2 | | | | | |

As indicated in Table 1, polyimide films fabricated according to Examples 1 through 12 can have a 60° gloss value smaller than 60 GU. The solvent content, and the temperature and the pressure of the embossing roller seem to have an impact on the gloss of the fabricated polyimide film: the gloss of the film may be reduced with an increase in the solvent content, an increase in the temperature of the embossing roller, and/or an increase in the pressure of the embossing roller.

According to an implementation, films having reduced gloss are preferably fabricated with a surface temperature of the roller between 160° C. and 190° C. and a roller pressure between 4 kg and 8 kg. These processing conditions can be effectively implemented and provide a stable film thickness.

Realizations of the fabrication process and polyimide films have been described in the context of particular embodiments. These embodiments are meant to be illustrative and not limiting. Many variations, modifications, additions, and improvements are possible. These and other variations, modifications, additions, and improvements may fall within the scope of the disclosure as defined in the claims that follow.

What is claimed is:

1. A process of fabricating a polyimide film, comprising:
forming a polyimide precursor solution obtained by reacting diamine monomers with dianhydride monomers in a solvent;
forming a wet film on a support with the polyimide precursor solution;
pressing the wet film with an embossing roller at a temperature equal to or higher than 100° C., the embossing roller applying a pressure equal to or higher than 1 kg, thereby causing the wet film to exhibit an uneven surface; and
heating the wet film to form a polyimide film.

2. The process according to claim 1, wherein the diamine monomers are selected from the group consisting of 4,4′-oxydianiline (4,4′-ODA), p-phenylene diamine (p-PDA), and 2,2′-bis(trifluoromethyl) benzidine (TFMB), and the dianhydride monomer is selected from the group consisting of pyromellitic dianhydride (PMDA), 3,3′,4,4′-biphenyltetracarboxylic dianhydride (BPDA) and 2,2-bis[4-(3,4-dicarboxyphenoxy) phenyl]propane dianhydride (BPADA).

3. The process according to claim 1, wherein the step of pressing the wet film with an embossing roller is conducted with a temperature of the embossing roller between 160° C. and 190° C. and an applied pressure between 4 kg and 8 kg.

4. The process according to claim 1, wherein the solvent is present in a quantity between 20 wt % and 50 wt % based on the total weight of the polyimide precursor solution.

5. The process according to claim 1, wherein the provided polyimide precursor solution includes a matting agent.

6. The process according to claim 1, wherein the polyimide precursor solution includes a black pigment selected from the group consisting of carbon black, cobalt oxide, Fe—Mn—Bi black, Fe—Mn oxide spinel black, (Fe,Mn)₂O₃ black, copper chromite black spinel, lampblack, bone black, bone ash, bone char, hematite, iron oxide black, micaceous iron oxide, black complex inorganic color pigment (CICP), CuCr₂O₄ black, (Ni,Mn,Co)(Cr,Fe)₂O₄ black, aniline black, cyanine black, perylene black, anthraquinone black, chrome green black hematite, and iron-chromium mixed oxides.

7. The process according to claim 6, wherein the polyimide film has a 60° gloss value equal to or less than 60 gloss units.

8. A polyimide film derived from diamine and dianhydride monomers and containing a matting agent, the polyimide film being formed with an uneven surface having a 60° gloss value equal to or less than 60.

9. The polyimide film according to claim 8, further including a black pigment selected from the group consisting of carbon black, cobalt oxide, Fe—Mn—Bi black, Fe—Mn oxide spinel black, (Fe,Mn)₂O₃ black, copper chromite black spinel, lampblack, bone black, bone ash, bone char, hematite, iron oxide black, micaceous iron oxide, black complex inorganic color pigment (CICP), CuCr₂O₄ black, (Ni,Mn,Co)(Cr,Fe)₂O₄ black, aniline black, cyanine black, perylene black, anthraquinone black, chrome green black hematite, and iron-chromium mixed oxides.

10. The polyimide film according to claim 8, wherein the matting agent includes polyimide particles.
